(19) United States
(12) Patent Application Publication
(10) Pub. No.: US 2011/0023714 A1
(43) Pub. Date: Feb. 3, 2011

(54) METHOD AND DEVICE FOR REGENERATING THE LOADED DETERGENT IN A PHYSICAL GAS SCRUBBER

(76) Inventors: Horst Weiss, Munchen (DE); Ulvi Kerestecioglu, Geltendorf (DE); Ulrich Prussner, Munchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/745,012

(22) PCT Filed: Nov. 27, 2007
(86) PCT No.: PCT/EP07/10297

§ 371 Date: Oct. 18, 2010

(51) Int. Cl. B01D 19/00

(52) U.S. Cl. 95/165; 96/202

(57) ABSTRACT

The invention relates to a process for scrubbing medium regeneration in a physical gas scrubbing, in which predominantly substances of a first type are separated from a laden scrubbing medium (2, 17) by stripping (cold stripping) in a stripping column (enrichment column (A)) and predominantly substances of a second type are separated from a laden scrubbing medium (2, 17) by subsequent thermal regeneration in a thermal regeneration column (H), and to an apparatus for carrying out the process. The laden scrubbing medium (6) is, after the cold stripping, withdrawn from the enrichment column (A), preheated (E1), expanded (a) and subsequently subjected to a thermal desorption in a device for carrying out a thermal desorption (thermal desorption device (W)), in which the content of substances of the first type in the laden scrubbing medium is further reduced.

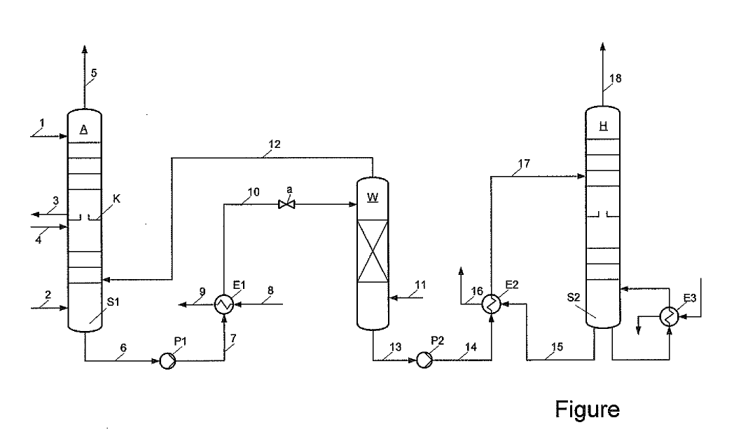

The invention relates to a process for scrubbing medium regeneration in a physical gas scrubbing, in which predominantly substances of a first type can be separated from a laden scrubbing medium by stripping (cold stripping) in a stripping column (enrichment column) and predominantly substances of a second type can be separated from a laden scrubbing medium by subsequent thermal regeneration in a thermal regeneration column, and an apparatus for carrying out the process.

Physical gas scrubbing operations make use of the property of liquids of absorbing gaseous substances and of keeping them in solution, without chemically bonding these substances in the process. How well a gas is absorbed by a liquid is expressed by the solubility coefficients: the better the gas dissolves in the liquid, the greater its solubility coefficient. The solubility coefficient is temperature dependent and generally increases with decreasing temperature.

Subsequent to the gas scrubbing, the laden scrubbing medium is regenerated by removal of the scrubbed-out gas components dissolved in the scrubbing medium. The regenerated scrubbing medium is normally reused in the gas scrubbing, while the scrubbed-out gas components are either disposed of or exploited economically.

Physical scrubbing operations are preferably used for the purification of crude synthesis gases, which are produced on the industrial scale in gasification plants from coal and/or hydrocarbon feedstocks, for example by reforming with steam or by partial oxidation, and which generally comprise some undesirable constituents, such as water, carbon dioxide (CO₂), hydrogen sulphide (H₂S) and carbonyl sulphide (COS). These processes are suitable since crude synthesis gases are currently generally produced under high pressure and the effectiveness of physical scrubbing operations increases to a first approximation linearly with the operating pressure. Methanol scrubbing is of particular importance for the purification of crude synthesis gases. It makes use of the fact that the solubility coefficients of H₂S, COS and CO₂ in methanol differ strongly from those of hydrogen (H₂) and carbon monoxide (CO). Since these differences increase with falling temperature and accordingly the H₂ and CO losses decrease, the methanol scrubbing medium is for the most part introduced with a temperature lying far below 0° C. into a scrubbing column and is brought into intimate contact with the synthesis gas to be purified.

For regeneration, the laden methanol scrubbing medium according to the state of the art is withdrawn from the scrubbing column and first fed to the upper zone of an “enrichment column”, which is a stripping column. In the enrichment column, a stripping gas conveyed countercurrentwise extracts predominantly CO₂ from the methanol scrubbing medium, which is cooled down in the process. The cold produced in this way is at the same time used to reduce the unavoidable losses in cold of a methanol scrubbing operation.

The methanol scrubbing medium, certainly reduced in its CO₂ content but still laden with sulphur compounds and residual CO₂, is withdrawn from the bottom of the enrichment column, preheated and fed to a thermal regeneration column, where it is separated into a bottom product exhibiting a pure scrubbing medium and a top fraction consisting predominantly of sulphur compounds.

In order to increase the profitability of such a synthesis gas scrubbing, the top fraction from the thermal regeneration column is fed to a sulphur extraction plant (e.g., a Claus plant) and there converted to elemental sulphur. The top fraction can accordingly be exploited in this way but its CO₂ content may not exceed a limiting value. In particular then, if the crude synthesis gas to be purified exhibits a low sulphur content, such as is the case, for example, with crude synthesis gas produced by the gasification of low-sulphur coal this limiting value can be achieved only at high cost (e.g., by cold stripping with an increased amount of stripping gas) or cannot be achieved at all.

It is accordingly an object of the present invention to provide a process of the type mentioned at the start and also a device for carrying out the process through which the disadvantages of the state of the art can be circumvented.

This object is, in terms of the process, achieved according to the invention by withdrawing the laden scrubbing medium from the enrichment column after the cold stripping, preheating, warming up, expanding and subsequently subjecting to a thermal desorption in a device for carrying out a thermal desorption (thermal desorption device), in which the content of substances of the first type in the laden scrubbing medium is further reduced.

The term “thermal desorption” is in this connection to be understood in such a way that the expulsion of undesirable substances from the scrubbing medium to be regenerated is carried out at higher temperatures than with those of the cold stripping preceding the thermal desorption and at lower temperatures than with those of the thermal regeneration succeeding the thermal desorption. Because of the strong temperature dependence of the solubility coefficients, the separation of the substances of the first type from the laden scrubbing medium is achieved, through the use of the thermal desorption according to the invention, with a smaller amount of stripping gas than is possible by cold stripping alone.

Preferred process variants provide for the preheated laden scrubbing medium to be subjected, for thermal desorption, to an expansion or a stripping (hot stripping) with a stripping gas (hot stripping gas). An additional preferred process variant provides for the preheated laden scrubbing medium to be subjected, for thermal desorption, to an expansion and the liquid fraction formed in the expansion to be treated by hot stripping with hot stripping gas.

Another preferred embodiment of the process according to the invention provides for the same gas, preferably nitrogen, to be used as stripping gas both for the cold stripping and the hot stripping.

With increasing hot stripping temperature, i.e. with increasing temperature with which the laden scrubbing medium is fed to a hot stripping, the amount of the substances of the second type also increases, which amount passes over from the laden scrubbing medium into the hot stripping gas and is carried off with this from the hot stripper as “top gas”. If the substances of the second type for example have an economic use, it is desirable to separate these substances as completely as possible from the scrubbing medium to be regenerated, i.e. to extract said substances with the highest possible yield. A preferred embodiment of the process according to the invention accordingly provides for the gas stream (top gas) produced in a hot stripping, consisting of hot stripping gas and the substances separated from the laden scrubbing medium, to be withdrawn from the top of the hot stripper and to be fed to the enrichment column in its lower part. In the enrichment column, the substances of the second type are scrubbed out from the top gas by the scrubbing medium to be regenerated, which is conveyed countercurrentwise, and in this way finally end up in the stream of substances of the second type produced in the thermal regeneration column.

If the thermal desorption according to the invention comprises, as processing stage, simply an expansion of the preheated laden scrubbing medium, the gas phase formed in this connection is composed largely of substances of the first type, so that the gas phase, because of its high purity, e.g., can have a direct economic use.

As already explained further above, the effectiveness of a physical gas scrubbing increases with falling temperature of the scrubbing medium used. Accordingly, an embodiment of the process according to the invention provides for the energy for the preheating of the laden scrubbing medium withdrawn from the enrichment column to be drawn from regenerated scrubbing medium, resulting in the regenerated scrubbing medium being cooled down. In this way, at least a portion of the cold produced in the cold stripping is used for the purpose of compensating for the losses in cold which are unavoidable in practice in a physical gas scrubbing.

A preferred embodiment of the process according to the invention provides for the purification, in the physical gas scrubbing, with methanol as scrubbing medium, of a crude synthesis gas comprising carbon dioxide (CO₂) and sulphur compounds. In this connection, the CO₂ represents the first type of substance and the sulphur compounds represent the second type of substance which are separated separately from the laden methanol scrubbing medium.

The invention furthermore relates to an apparatus for scrubbing medium regeneration in a physical gas scrubbing, exhibiting a stripping column (enrichment column), for the separation of substances of a first type, and a thermal regeneration column, for the separation at least of substances of a second type, from a laden scrubbing medium.

In terms of the apparatus, the object set is achieved by providing, between the enrichment column and the thermal regeneration column, at least one heat exchanger for preheating a laden scrubbing medium withdrawn from the enrichment column and one device for carrying out a thermal desorption (thermal desorption device), it being possible for the laden scrubbing medium preheated in the heat exchanger to be introduced into the thermal desorption device for an additional separation of substances of the first type.

Preferred embodiments of the apparatus according to the invention provide for the thermal desorption device to be implemented as expansion vessel or as stripping column (hot stripper) or as combination of an expansion vessel and an in-line hot stripper.

Another preferred embodiment of the apparatus according to the invention provides for it to be possible to supply the same gas, preferably nitrogen, as stripping gas both to the enrichment column and to a hot stripper.

During the thermal desorption, in addition to substances of the first type, those of the second type are also separated from the laden scrubbing medium in a hot stripper and pass over in the stripping gas used in the hot stripper. In order to separate from one another the substances of the first and second types present in the stripping gas, one embodiment of the apparatus according to the invention provides for a hot stripper to be connected to the enrichment column in such a way that the gas stream (top gas) produced in the hot stripping in the hot stripper from the stripping gas and the substances separated from the laden scrubbing medium can be introduced into the lower part of the enrichment column. Advantageously, the apparatus according to the invention comprises a pump situated between the enrichment column and the hot stripper, by means of which the pressure of the laden scrubbing medium withdrawn from the enrichment column can be boosted. Preferably, the pressure can be boosted by the pump thus far that sufficient pressure is available for the expansion of the laden scrubbing medium in the hot stripper and the top gas flows back to the enrichment column without additional compression.

If the thermal desorption device comprises simply an expansion vessel, variants of the apparatus according to the invention provide for it to be possible to make direct economic use of the gas phase formed in the expansion vessel.

An additionally preferred embodiment of the apparatus according to the invention provides for the possibility of transferring heat energy in the heat exchanger from a scrubbing medium stream, fed back to the physical gas scrubbing, to a laden scrubbing medium withdrawn from the enrichment column.

The apparatus according to the invention is particularly suitable for use in methanol scrubbing operations, in which CO₂ (first type of substance) and sulphur compounds (second type of substance) are scrubbed out from a crude synthesis gas comprising at least carbon dioxide (CO₂) and sulphur compounds and are separately extracted during the regeneration of the laden methanol scrubbing medium.

The invention makes it possible to isolate substances of a first type from a laden scrubbing medium considerably more effectively than is possible according to the state of the art. Using the same amount of stripping gas, much less of the substances of the first type pass into the material stream produced by thermal regeneration, which is predominantly composed of substances of the second type. The substances of the second type are accordingly extracted in pure form and can accordingly be further treated more simply and more economically.

In the following, the invention should be explained in more detail by means of an exemplary embodiment represented diagrammatically in the FIGURE. The exemplary embodiment concerns a part of the scrubbing medium regeneration in a physical gas scrubbing in which a crude synthesis gas contaminated with carbon dioxide (CO₂) and sulphur compounds is scrubbed out in a scrubbing column with cold methanol scrubbing medium. Nitrogen is used as stripping gas both in the enrichment column and in the hot stripping column.

Laden methanol scrubbing medium is introduced into the upper section of the enrichment column A via line 1, where a portion of the amount of CO₂ present therein is stripped off by means of nitrogen, which is introduced into the enrichment column A via the lines 2 and 12 as stripping gas. The temperature of the methanol scrubbing medium decreases so much down to reaching the tower plate K that it becomes virtually impossible for stripping of the CO₂ to continue. The laden methanol scrubbing medium is accordingly withdrawn from the enrichment column A via line 3, conveyed to a (not represented) heat exchanger and there preheated in indirect heat exchange with regenerated methanol scrubbing medium flowing towards the scrubbing column (not represented). The preheated laden methanol scrubbing medium is carried via line 4 back into the enrichment column A and there subjected to a further stripping, in which both its CO₂ content and its temperature are reduced. The stripping gas, laden with stripped-off components (predominantly CO₂), is withdrawn from the top of the enrichment column A via line 5, while cold methanol scrubbing medium, which still comprises residual carbon dioxide and the bulk of the sulphur compounds, is conveyed out of the bottom space S1 via line 6.

The pressure of the cold laden methanol scrubbing medium is boosted by means of the pump P1, before it is fed via line 7 to the heat exchanger E1. Here it is preheated in indirect heat exchange against regenerated methanol scrubbing medium supplied via line 8 and evacuated via line 9. The laden methanol scrubbing medium is heated up so much that, after being withdrawn from the heat exchanger E1 via line 10 and being expanded via the throttle element a, it enters the hot stripper W with a temperature which is greater than the temperatures with which the methanol scrubbing medium to be regenerated is introduced into the enrichment column A. Additional CO₂ and sulphur compounds are stripped off from the laden methanol scrubbing medium in the hot stripper W, to which nitrogen is conveyed as stripping gas via line 11. The laden stripping gas is evacuated as top gas via line 12 and introduced into the lower part of the enrichment column A. The sulphur compounds present in the top gas are scrubbed out in the enrichment column A by laden methanol scrubbing medium and thus again end up back in the bottom space S1.

Methanol scrubbing medium, poor in CO₂ but still laden with sulphur compounds, is withdrawn from the hot stripper W via line 13 using the pump P2 and introduced into the heat exchanger E2 via line 14, where it is preheated in indirect heat exchange against regenerated methanol scrubbing medium from the bottom space S2 of the thermal regeneration column H supplied via line 15 and evacuated via line 16. The laden methanol scrubbing medium is introduced via line 17 into the upper part of the thermal regeneration column H heated via the reboiler E3 and the sulphur compounds are largely separated therein from the laden methanol scrubbing medium and fed in highly concentrated form via line 18 to a Claus plant (not represented) for economic use.

1. A process for regeneration of scrubbing medium from a physical gas scrubbing step, in which predominantly substances of a first type are separated from a laden scrubbing medium by cold stripping in a stripping enrichment column and predominantly substances of a second type are separated from a laden scrubbing medium by subsequent thermal regeneration in a thermal regeneration column, characterized in that the laden scrubbing medium, after the cold stripping, is withdrawn from the enrichment column, preheated, expanded and subsequently subjected to a thermal desorption so as to reduce the content of substances of the first type in the laden scrubbing medium, said thermal desorption being conducted at a higher temperature than said cold stripping and a lower temperature than said thermal regeneration.

2. A process according to claim 1, wherein the preheated laden scrubbing medium is subjected, for thermal desorption, to an expansion.

3. A process according to claim 1, wherein the preheated laden scrubbing medium is subjected, for thermal desorption, to a stripping with hot stripping gas or to an expansion and a subsequent hot stripping.

4. A process according to claim 3, wherein stripping gas both for the cold stripping and for the hot stripping is the same gas.

5. A process according to claim 4, wherein a top gas stream produced in the hot stripping, comprising hot stripping gas and the substances separated from the laden scrubbing medium, is withdrawn from the top of a hot stripper zone and fed to a lower part of the enrichment column.

6. A process according to claim 1, wherein, in the physical gas scrubbing step, a crude synthesis gas comprising carbon dioxide (CO₂) and sulphur compounds is purified with methanol as scrubbing medium.

7. A process according to claim 5, characterized in that, in the physical gas scrubbing step, a crude synthesis gas comprising carbon dioxide (CO₂) and sulphur compounds is purified with methanol as scrubbing medium.

8. Apparatus for regeneration of scrubbing medium from a physical gas scrubbing, comprising a stripping enrichment column for the separation of substances of a first type from a laden scrubbing medium and a thermal regeneration column for the separation of substances of a second type from a laden scrubbing medium, characterized in that at least one heat exchanger for preheating a laden scrubbing medium withdrawn from the enrichment column and one device for carrying out a thermal desorption (thermal desorption device) are provided between the enrichment column and the thermal regeneration column, it being possible for the laden scrubbing medium preheated in the heat exchanger to be introduced into the thermal desorption device for an additional separation of substances of the first type.

9. Apparatus according to claim 8, characterized in that the thermal desorption device is implemented as expansion vessel.

10. Apparatus according to claim 8, characterized in that the thermal desorption device is implemented as stripping column (hot stripper) or as combination of an expansion vessel and an in-line hot stripper.

11. Apparatus according to claim 8, characterized in that the hot stripper is connected to the enrichment column in such a way that the gas stream (top gas) produced in the hot stripping in the hot stripper from the stripping gas and the substances separated from the laden scrubbing medium can be introduced into the lower part of the enrichment column.

12. Apparatus according to claim 8, characterized in that, in the heat exchanger, heat energy can be transferred from a scrubbing medium stream, fed back to the physical gas scrubbing, to a laden scrubbing medium withdrawn from the enrichment column.
